(19) United States
(12) Patent Application Publication
(10) Pub. No.: US 2008/0229594 A1
(43) Pub. Date: Sep. 25, 2008

(54) Spirit Level

(76) Inventor: Paul Steiner, Kadarim (IL)

Correspondence Address: NATH & ASSOCIATES, 112 South West Street, Alexandria, VA, 22314, US

(21) Appl. No.: 11/922,611

(22) PCT Filed: Feb. 28, 2005
(86) PCT No.: PCT/IL2005/000237

§ 371 Date: Dec. 20, 2007

(30) Foreign Application Priority Data
Mar. 11, 2004 (IL) 160833

(51) Int. Cl. G01C 9/24

(52) U.S. Cl. 33/371; 33/379

(57) ABSTRACT

A spirit level including an aluminum body having at least one unpainted leveling surface for placing on a surface and a bubble vial for indicating the inclination of the surface to the horizontal wherein an unpainted leveling surface of the at least one unpainted leveling surface is protected by a readily manually removable elongated protective strip.

### FIELD OF THE INVENTION

The invention is in the field of spirit levels.

### BACKGROUND OF THE INVENTION

Contractor grade and other top of the range spirit levels are typically made from aluminum as opposed to plastic, and have either a single or a pair of opposite metal or anodized machined leveling surfaces hereinafter commonly referred to as “unpainted leveling surfaces”. Many professional users of such spirit levels select a new spirit level with the same care and attention to detail that, for example, a tennis player selects a new tennis racket, namely, testing for its comfort, balance, and weight. Moreover, professional users are accustomed to test a new spirit level at a point of purchase (POP) for accuracy by determining whether it shows the same reading in two indexable positions which indicates that it is accurate. The use of PVC shrink wrapping to entirely protect contractor grade or other top of the range spirit levels is becoming more prevalent to prevent damage until after purchase. But PVC shrink wrapping precludes testing for accuracy unless it is removed, and moreover its disposal is now becoming a major environmental issue in many countries.

### SUMMARY OF THE INVENTION

The present invention is for a spirit level having an aluminum body with a single unpainted leveling surface or a pair of opposite unpainted leveling surfaces each preferably protected by a readily manually removable protective strip for protecting same against scratching, marring, and the like. The protective strips may be transparent for allowing visual inspection of the leveling surfaces without their removal. Additionally or alternatively, the protective strips may double as information bearing substrates for advertising purposes, and the like.

Protective strips may be in the form of disposable protective tapes of pliable thermoplastic protective material, for example, as now employed for protecting display screens of new mobile phones. Suitable pliable thermoplastic protective materials include inter alia polyester, polypropylene, and the like. Such protective tapes are intended to protect leveling surfaces until after purchase when they are peeled off by a user but still enable a user to test a spirit level at a POP for both its feel and accuracy because of their ultra fine thickness and the uniform homogenous manner in which they adhere to surfaces. Moreover, such protective tapes are also easier to dispose of then PVC shrink wrapping by virtue of their considerably lesser bulk.

Alternatively, protective strips may be in the form of elongated guards made of suitable resiliently flexible thermoplastic materials, for example, Polypropylene (PP), Acrylonitrile Butadiene Styrene (ABS) and the like, for manually replaceable fitting onto a spirit level. Such guards may have a rimmed U-shaped end profile for snap fitting onto a spirit level or an inwardly tapering U-shaped end profile for press fitting onto a spirit level depending on its end profile. Such guards enable a user to test a spirit level at a POP upon their removal, and have the advantage of protecting a spirit level both before and after purchase thereby possibly extending its lifetime.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a front view of an I-beam cross section spirit level with a single unpainted leveling surface protected by a partially removed peel off protective tape;

FIG. 2 is a front view of a rectangular box cross section spirit level with a pair of opposite unpainted leveling surfaces, and a pair of snap on guards for protecting same;

FIG. 3 is an end view of the spirit level of FIG. 2;

FIG. 4 is an end view of the spirit level of FIG. 2 with the guards snap fitted thereon for protecting its unpainted leveling surfaces;

FIG. 5 is a front view of a rectangular box cross section spirit level with a pair of opposite unpainted leveling surfaces, and a pair of press on guards for protecting same;

FIG. 6 is an end view of the spirit level of FIG. 5; and

FIG. 7 is an end view of the spirit level of FIG. 5 with the guards press fitted thereon for protecting its unpainted leveling surfaces.

### DESCRIPTION OF PREFERRED EMBODIMENTS OF THE INVENTION

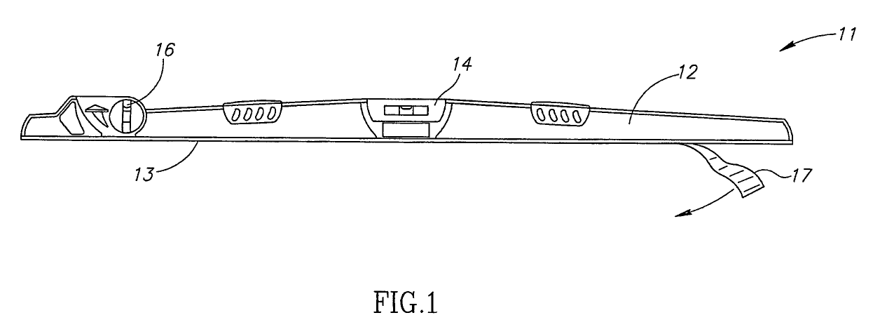

FIG. 1 shows an I-beam cross section spirit level 11 having a cast aluminum body 12 with a single unpainted leveling surface 13 for placing on a surface, a horizontal bubble vial 14 for indicating the inclination of a surface with respect to the horizontal, and a vertical bubble vial 16 for indicating the inclination of a surface with respect to the vertical. The leveling surface 13 is protected by a readily manually removable peel off self adhering protective tape 17 constituting a protective strip made from suitable pliable thermoplastic material including inter alia:

1) 3M's Transparent Polyester Tape 336 whose product data sheet was available on Mar. 4, 2004 at the following URL:

http://products3.3m.com/catalog/us/en001/manufacturing_industry/sp

ecialty_tapes/node_GSNT1F5XRRbe/root_GST1T4S9TCgv/vroot_GSNYT
MLW46ge/gvel_GS6XF7X9ZXgl/theme_us_specialtytapes_3_0/command_A
bcPageHandler/output_html

2) 3M's Automotive Protective Tape 64S58 whose product data sheet was available on Mar. 4, 2004 at the following URL:

http://products3.3m.com/catalog/us/en001/manufacturing_industry/sp

ecialty_tapes/node_DW9C9B4RQCbe/root_GST1T4S9TCgv/vroot_GSNYT
MLW46ge/gvel_FPGX6J29RQgl/theme_us_specialtytapes_3_0/command_A
bcPageHandler/output_html

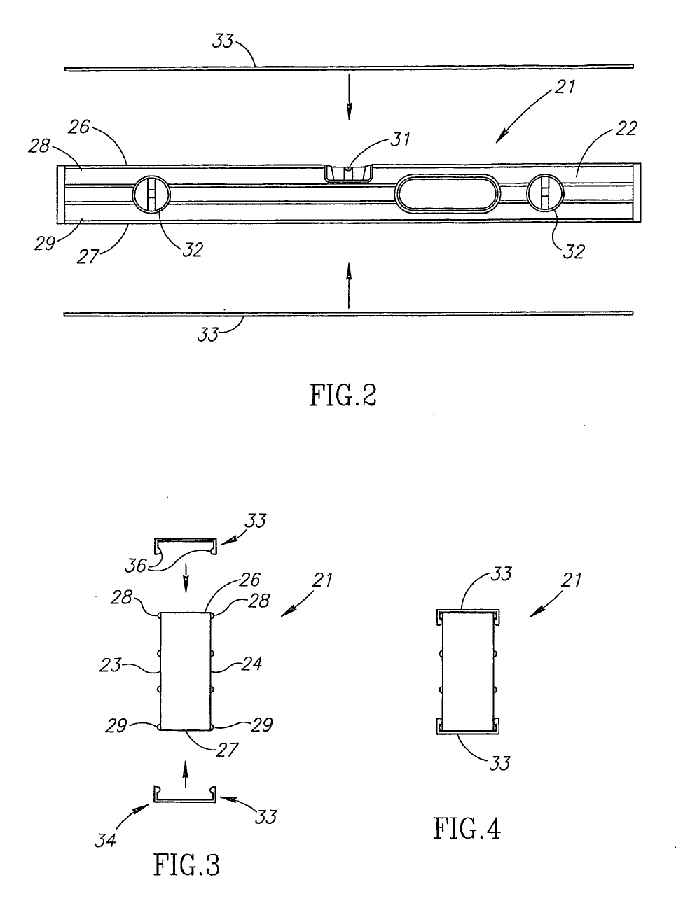

FIGS. 2 and 3 show a rectangular box cross section spirit level 21 having an extruded aluminum body 22 with a pair of major surfaces 23 and 24, and upper and lower unpainted leveling surfaces 26 and 27 for placing on a surface. The major surfaces 23 and 24 are formed with a pair of opposite parallel uppermost ridges 28 extending therealong with the upper unpainted leveling surface 23 extending therebetween, and a pair of opposite parallel lowermost ridges 29 extending therealong with the lower unpainted leveling surface 24 extending therebetween. The spirit level 21 includes a horizontal bubble vial 31 for indicating the inclination of a surface with respect to the horizontal, and a pair of vertical bubble vials 32 for indicating the inclination of a surface with respect to the vertical. FIGS. 2 and 3 also show a pair of identical elongated guards 33 with a rimmed U-shaped end profile 34 having elongated rims 36 for snap fitting onto the ridges 28 and 29 for protecting the leveling surfaces 23 and 24 (see FIG. 4).

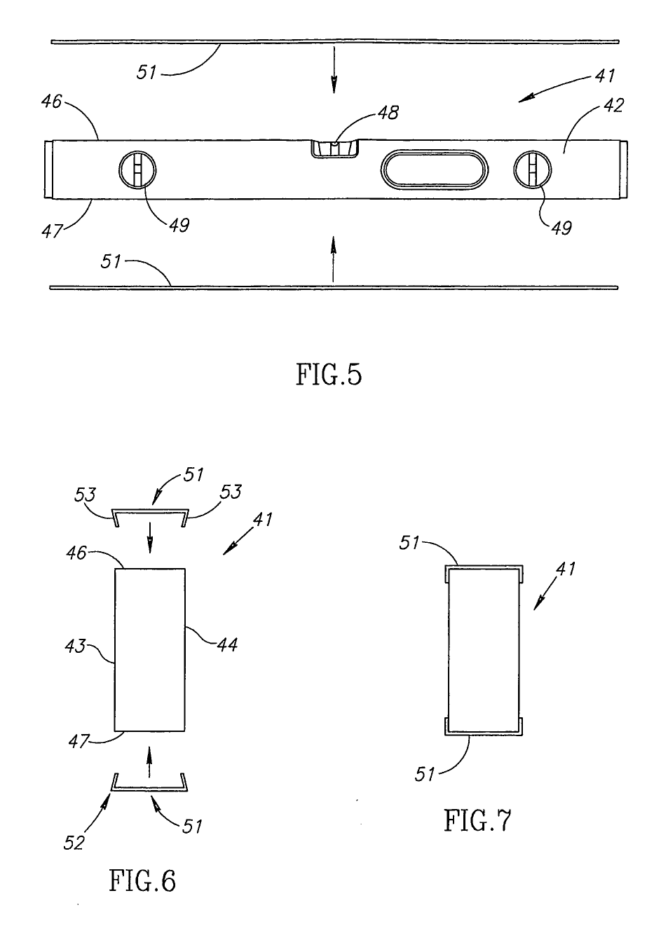

FIGS. 5 and 6 show a rectangular box cross section spirit level 41 having an extruded aluminum body 42 with a pair of major surfaces 43 and 44, and upper and lower unpainted leveling surfaces 46 and 47 for placing on a surface. The spirit level 41 includes a horizontal bubble vial 48 for indicating the inclination of a surface with respect to the horizontal, and a pair of vertical bubble vials 49 for indicating the inclination of a surface with respect to the vertical. FIGS. 5 and 6 also show a pair of identical elongated guards 51 with a tapering U-shaped end profile 52 with inwardly converging side walls 53 for press fitting onto the spirit level 41 for protecting its leveling surfaces 46 and 47 (see FIG. 7).

While the invention has been described with respect to a limited number of embodiments, it will be appreciated that many variations, modifications, and other applications of the invention can be made within the scope of the appended claims.

1. A spirit level comprising an aluminum body having at least one unpainted leveling surface for placing on a surface and a bubble vial for indicating the inclination of the surface to the horizontal wherein an unpainted leveling surface of said at least one unpainted leveling surface is protected by a readily manually removable elongated protective strip.

2. The level according to claim 1 wherein a protective strip is constituted by a disposable peel off pliable thermoplastic protective tape for adhering to an unpainted leveling surface prior to its removal therefrom.

3. The level according to claim 2 wherein said protective tape has a self adhering tape construction of suitably low adhesive tack level for minimal adhesion build-up on an unpainted leveling surface.

4. The level according to claim 1 wherein a protective strip is constituted by a resiliently flexible thermoplastic elongated guard with a substantially U-shaped end profile for manually replaceable fitting onto said aluminum body to protect an unpainted leveling surface.

5. The level according to claim 4 wherein said protective strip has a rimmed U-shaped end profile for snap fitting onto said aluminum body.

6. The level according to claim 4 wherein said protective strip has a tapering U-shaped end profile for press fitting onto said aluminum body.

7. The level according to any one of claims 1 to 6 wherein a protective strip is transparent.

8. The level according to any one of claims 1 to 7 wherein a protective strip doubles as an information bearing substrate.
